(19) United States
(12) Patent Application Publication
(10) Pub. No.: US 2010/0257036 A1
(43) Pub. Date: Oct. 7, 2010

(54) Method and System for Anonymity and Incentives in User-Assisted Mobile Services

(75) Inventors: Mohammad A. Khojastepour, North Brunswick, NJ (US); Ravindranath Kokku, Monmouth Junction, NJ (US); Karthikeyan Sundaresan, Howell, NJ (US); Sampath Rangarajan, Bridgewater, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/753,140

(22) Filed: Apr. 2, 2010

Related U.S. Application Data
(60) Provisional application No. 61/166,031, filed on Apr. 2, 2009.
(60) Provisional application No. 61/166,029, filed on Apr. 2, 2009.

(51) Int. Cl. G06Q 30/00; G06F 15/16; G06Q 10/00; G08B 1/08

(52) U.S. Cl. 705/14.11; 709/219; 705/14.26; 340/539.13

(57) ABSTRACT

A method includes transmitting location-specific information by a user device to a service provider, preserving anonymity of the user device in the transmitting, providing incentives to the user device for information upload to the service provider, and disabling the service provider from associating the user device with the information upload and the location specific information for promoting the information upload.

This application claims the benefit of U.S. Provisional Application No. 61/166,031, entitled “Mechanisms for Incentives, Data Validation and Anonymity in User-assisted Mobile Services”, filed on Apr. 2, 2009, and U.S. Provisional Application No. 61/166,029, entitled “Mechanisms for Incentives, Data Validation and Anonymity in User-assisted Mobile Services”, filed on Apr. 2, 2009, the contents of which are incorporated by reference herein.

### FIELD OF THE INVENTION

The present invention relates generally to wireless communications, and more particularly, a method and system for anonymity and incentives in user-assisted services.

### BACKGROUND OF THE INVENTION

Mobile devices have seen enormous growth in the recent years. The number of mobile connections has crossed the 4 billion mark in February 2009, and is expected to cross 6 billion by 2013. It is envisioned that this ubiquity of mobile devices will soon enable a rapid growth of a new class of location-specific real-time services. In these services, a user U at a location B is interested in current information about location A. At the same time, there are users at location A that can potentially provide the necessary information to U. Examples of such location-specific real-time information include traffic conditions, parking availability in busy locations, population density in a mall, live videos of an event such as a football game, radio spectrum availability (such as in opportunistic cognitive radio networks) and radio resource parameters (such as best base station to handoff, transmit power and bit rate) for efficient communication, etc. In effect, such real-time applications can be enabled easily by having user devices upload location-specific information as opposed to using dedicated sensor infrastructure.

To sustain a service under the above model, where users are continuously willing to provide real-time information at different locations, a service provider has to encompass three features. 1) Similar to payments for receiving continued updates from a service, users need incentives to be continuously engaged with the service for uploading even when they have no need for using the service. 2) Users desire anonymity while providing information mainly to ensure that the knowledge of presence of the particular user at a particular location, or the information itself sent by a user (such as speed above the speed-limit of a road) is not used against him. 3) The service infrastructure has to validate the location specific information received from each user at a location, and give incentives according to the validity of the information, i.e., how well a user's updates conform to other users' updates. It appears that the two features-anonymity and incentives are conflicting; while information can be anonymized when the user uploads, it makes providing incentives hard. Even the use of pseudonyms have limitations in that when the incentives are encashed, the user has to reveal his real information to receive the actual reward (such as cash, gift cards, coupons, etc.), which can in turn be used to map back to the specific information uploaded. Hence, pseudonyms will be only useful in providing anonymity as long as they are encashed within the system.

A user-assisted mobile service is considered to have three factors: 1) A pseudo-ID for the user to conceal the actual identity, which can be used during location-specific updates and for receiving reward points. 2) The location in which the user herself is present. 3) A real ID for the user (that may include a bank account information or address information, for instance) in order to encash reward points.

There are problems with providing anonymity in a mobile services environment. First, a mapping between pseudo-ID and real-ID will reveal the identity of the user, which can be used to map the updates to the specific real-ID. Second, a mapping of the most frequently visited location and an address information database (such as yellow pages) can reveal the real identity of the user, which can be mapped to the pseudo-ID and finally the updates the user made. Third, a pseudo-ID that cannot be mapped to a real-ID can be abused by an adversary to provide fake updates and disturb the accuracy of the service.

Traditionally, the anonymity problem in mobile services has focused on the second problem above. The main idea of the solutions is to provide k-anonymity to a user, which essentially means that the update will look like it came from any of k users around (the location of) the actual user. The method is often called “spatial cloaking”. This method, however, cannot be used for our purpose, since our goal is also to provide incentives to the specific user for her update. Secondly, it is not yet a common scenario that mobile services include updates from users, and that services provide incentives, along with providing anonymity. In the few applications where incentives are provided, anonymity has been compromised.

Accordingly, there is a need for providing anonymity in a mobile services environment in which the real identity of the user is not be revealed either by the location they are updating from, or when the users encash the reward points.

### SUMMARY OF THE INVENTION

A method includes transmitting location-specific information by a user device to a service provider, preserving anonymity of the user device in the transmitting, providing incentives to the user device for information upload to the service provider, and disabling the service provider from associating the user device with the information upload and the location specific information for promoting the information upload.

A wireless system includes a service provider responsive to a user device transmitting its location-specific information by a user and for providing an incentive to said user device for an information upload to said service provider while preserving anonymity of said user device with said service provider being incapable of associating said user device with said respective information upload and said location specific information.

### BRIEF DESCRIPTION OF DRAWINGS

These and other advantages of the invention will be apparent to those of ordinary skill in the art by reference to the following detailed description and the accompanying drawings.

FIG. 1 is a diagram showing a mechanism for providing anonymity to users, in accordance with the invention.

FIG. 2 is a diagram of an exemplary structure of a Pseudo-ID, in accordance with the invention.

FIG. 3 is a diagram showing initialization for the encashment process, in accordance with the invention.

FIG. 4 is a diagram showing step 1 protocols to get currency denominations and corresponding keys, in accordance with the invention.

### DETAILED DESCRIPTION

The invention is directed to a method and apparatus that considers the three factors that can reveal the identity of a user: 1) a Pseudo-ID for the user to conceal the actual identity, which can be used during location-specific updates and for receiving reward points; 2) the location in which the user herself is present; and 3) a Real-ID for the user (that may include a bank account information or address information, for instance) in order to encash reward points; and decouples each of them during the various operations (of providing updates to services and encashing reward points) in such a way that the actual identity is not associated with the update a user makes. The Pseudo-ID is generated such that it can be easily verified by the service provider, and it cannot be generated by the user herself.

For avoiding the mapping between Pseudo-ID and Real-ID, the invention includes a two-step anonymous-but-verifiable encashment protocol that is described below. For avoiding the mapping between location updates and the real identity of the user through the use of public address databases, a randomly structured secret zone is used around the top few most frequently visited locations by the user. The user device either does not provide updates within this zone or provides updates with the location re-mapped onto the edge of the secret zone. The size of the secret zone can be made user configurable to allow users to make informed decisions. In densely populated places, the zones can be smaller than in sparse places. It is noted that the bigger the zone, the lower is the reward a user receives.

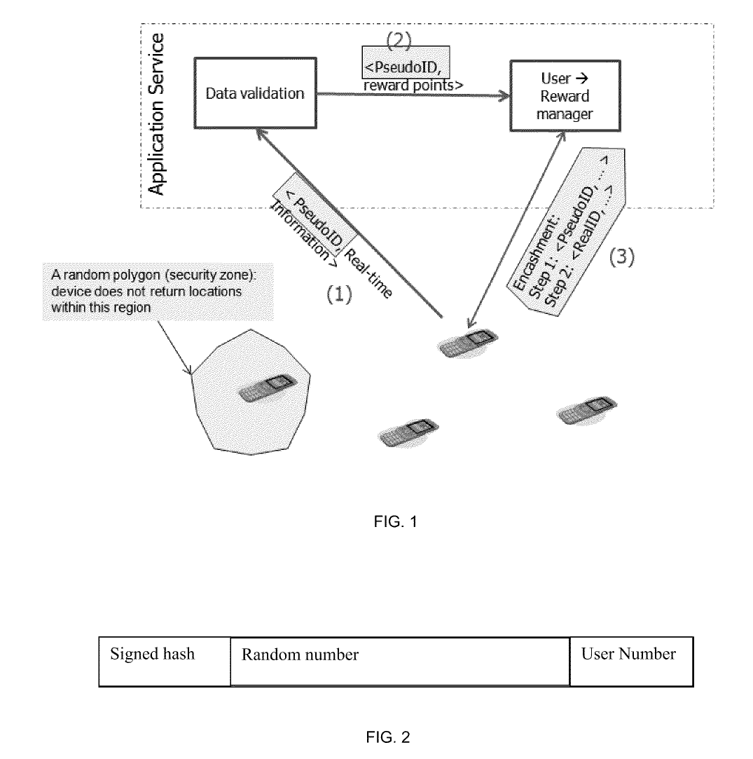

Turning now to FIG. 1, a diagram illustrating the inventive mechanism for providing anonymity to users, in accordance with the invention. A Pseudo-ID is involved when the user uploads information, and earns reward points. For encashing the reward points, in step 1 the Pseudo-ID is used, and in step 2 the Real-ID is used. The Real-ID could be the actual name of the user or other information that reveals the actual identity of the user. A security zone is created around the user's top few locations using a random polygon that is known only to the user. This polygon avoids the identification of the user even after receiving a lot of updates from the user, as long as the chance that there are other people (with valid real addresses) within the same polygon. The shaded regions in the diagram of FIG. 1 represent the critical features of the inventive anonymity technique: Pseudo-ID generation and Two-step encashment Protocol.

### Pseudo-ID Generation

In one instantiation of Pseudo-IDs, we assume that a network provider, who is trusted by both the user and the service provider, generates the Pseudo-ID for each user. Further, we assume that the network provider knows the Real-ID of the user, but will not reveal it to the service provider. Under this setup, the Pseudo-ID has the following structure shown in FIG. 2. The user number is an integer filed, e.g. 32-bit integer, which will be assigned in-order to the users. The random number is of sufficient length so that it, along with the user number is long enough for preventing an adversary to generate a valid ID herself.

Optionally, we can use a hash function to find the message digest for the entire random number and user number with secret initial value which is known only to the service provider and the network provider. Finally, the field signed hash is the signed version of the message digest or directly the signed version of the random number concatenated with the user number. This can be done by choosing a pair of public-private keys by the network provider where the public key is only provided to the service provider. It is of no harm to even reveal the public key to everybody as it only makes possible to check if a certain Pseudo-ID is valid or not; nobody other than the network provider can generate such Pseudo-ID as it requires the knowledge of the private key of the network provider. In an alternate implementation, the signed hash can be replaced by an encrypted hash which is only available to the service provider and network provider and nobody else.

The properties of the inventive Pseudo-ID are as follows:
1. Only the user and the network provider know the association between Real-ID and Pseudo-ID.
2. Pseudo-ID has a specific structure that allows the corresponding service provider to correctly verify it upon receipt without need to have the list of the name of the registered users be shared by the network provider.
3. No one but the network provider can issue a valid Pseudo-ID with the corresponding structure. In other words, knowing the structure is not enough for a malicious user to generate a valid Pseudo-ID. Also, if the malicious user by some means acquire the knowledge of a set of valid Pseudo-ID, he cannot yet reproduce any new Pseudo-ID besides using the ones that he has acquired.
4. Pseudo-ID is designed to allow extremely fast access to the user's data without need to search; the last few digits of the ID represents the user number that can be used to easily index and locate user-specific information.

### Twp-Step Encashment Process

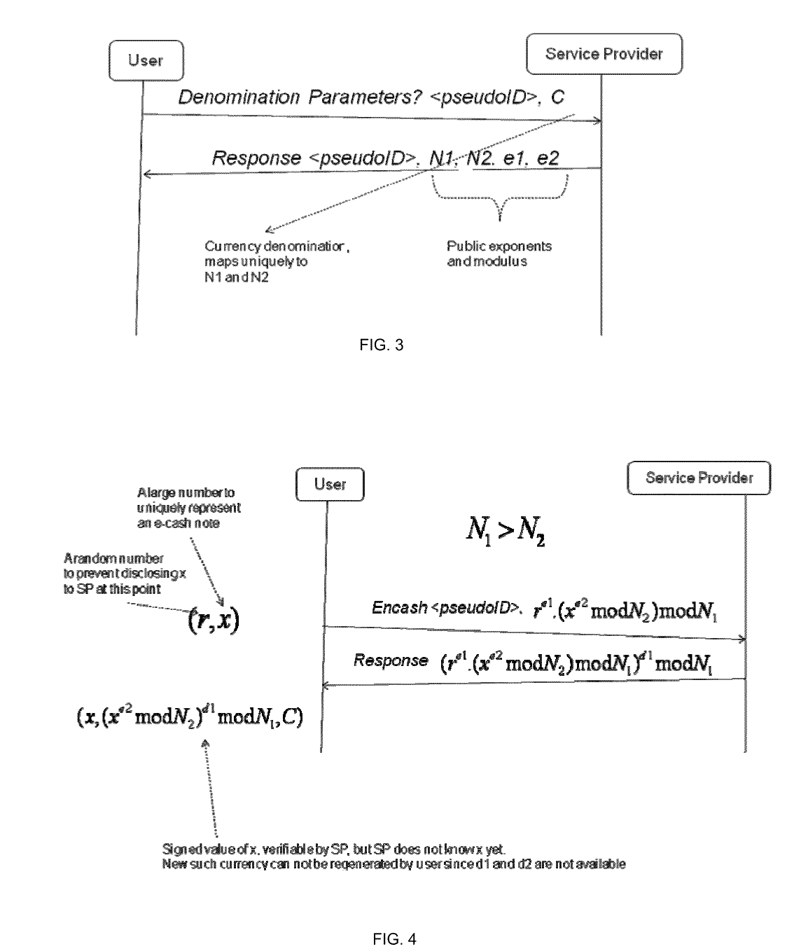

A two step cash redemption process is used for the reward points acquired by a user in his account. In the first step, the user generates the e-cash and does it by using his Pseudo-ID; the generated e-cash will be anonymous, which cannot by itself be used to trace either Real-ID or Pseudo-ID. In the second step, the user holding an e-cash certificate will redeem it for real money (or gift cards, merchandise, etc) by using his Real-ID. The diagrams of FIGS. 3 and 4 and the associated discussions thereof show how the messages are exchanged between the user and the service provider.

### Initialization

Turning now to the diagram of FIG. 3, the service provider decides ahead of time of what are the denomination amounts and generates a public-private key pair for each denomination (denoted by a key pair (e2,d2) in the figure) and make the set of public keys and corresponding modulus, e.g., (e2, N2), available to the public. The service provider also makes an encashing public-private key pair (e1, d1) that is used for all encashing procedures to provide a “blind signature”. It is assumed that all values of N2 for different currency denominations are smaller than N1 used for the blind signature.

The user explicitly asks for the system parameters that are necessary to generate e-cash currency for all or certain denominations. This information is public domain information and can be requested anytime and well ahead of time that the actual encashing is performed.

### Step 1: <Pseudo-ID, Credits>→E-Currency

During encashment, the user first engages with the service provider in a transaction in which the user generates verifiable information, while at the end of the transaction the anonymity of the user is preserved. The process goes by asking the service provider to blindly sign a piece of information with a given signature. The SP will do so and return the result to the user and reduces a nominal point from the user account. The point reduction depends on the type of the requested signature. Depending on different denomination amounts, the service providers deduct different number of points from the user account for different signature types. For error control, to make sure that the user does not lose money, the service provider keeps the record of the point reduction in the user account with the reply provided to the user. Thus, the user can later ask for the certain verification in case that the user has not received the service provider's response.

The diagram of FIG. 4 represents the above Step 1 and is explained as follows:
1. The user first selects the denomination amount and the corresponding public key pairs.
2. The user then generates a long encashing seed that can be thought of as the serial number in the printed money. This encashing seed, say x, has to be generated randomly and should have the property that it is uniformly random.
3. The user also selects another long random number, say r, to help making an anonymous inquiry.
4. The user generates the challenge number r^{e1}.(x^{e2} mod N₂) mod N₁ and sends it to the service provider
5. The service provider signs this message and returns

(r^{e1}.(x^{e2} mod N₂) mod N₁)^{d1} mod N₁
6. The user then calculates (x^{e2} mod N₂)^{d1} mod N₁
7. The generated currency is then {x, (x^{e2} mod N₂)^{d1} mod N₁, C} where C denotes the currency denomination.

The currency generation can be done alternatively by using a combination of a one-way cryptographic hash function and a public-private key system in the following way.
1. The user first selects the denomination amount. The system parameters is then a single public key crypto (N1, e1), and a cryptographic hash function Hash(.) which takes any input size and return a k-bit hash digest. It is assumed that finding the collision for this hash function is as hard as breaking the N1,e1 public key system.
2. The user then generates a long encashing seed, say x, as follows. The User first generates a random binary sequence W of the length [log2(N1)]−k and finds its k-bit hash value Hash(W). The random encashing seed is then found by concatenation of these values, i.e., x=concatenate(W, Hash(W)).
3. The user also selects another long random number, say r, to help making anonymous inquiry.
4. The user generates the challenge number r^{e1}.x mod N₁ and sends it to the service provider.
5. The service provider signs this message and returns (r^{e1} x mod N₁)^{d1} mod N₁
6. The user then calculates x^{d1} mod N₁
7. The generated currency is then {x, (x)^{d1} mod N₁, C} where C denotes the currency denomination.

This approach significantly reduces the computational complexity at the user (mobile) end and also would help the recordkeeping by the service provider as well. The idea is that the hash function has already been embedded in the initial seed and thus, the SP can store and search the database based on this value. In this implementation, the Hash function can be unified for all the denomination amounts and the signature would change from one denomination to another.

### Step 2: <Real-ID, E-Currency>→Real Currency

In the second step, the user generates a request using the Real-ID (and bank account information or postal address information) and the e-cash certificate received in the previous step. Since the generated e-cash certificate does not have any association to the user's Pseudo-ID, the service provider cannot make association between the e-cash certificate (and hence the real ID) to the information updates it corresponds to.

RECORDKEEPING: When a user redeems an e-cash certificate

{x, (x^{e2} mod N₂)^{d1} mod N₁, C}

as above, this value x is recorded into a table so that the same user or other users cannot re-claim it.

EFFICIENT SEARCH: The procedure of cash redemption at the service provider also involves searching the table of used certificates to ensure the originality of the newly claimed e-cash certificate. The size of this database will grow large over time as the number of certificates encashed increases. To enable efficient search in this database, we propose using hierarchical hash functions.

The idea is to use a hash function, say H1(x) where x is the e-cash seed, and keep the sorted values of x in order of their H1(x). When a new inquiry comes, the hash function of the new e-cash seed, say w, is calculated and is searched in the table. In case of collision, the original value w is compared with all the other e-cash seed x previously recorded in the table for the same hash value.

This idea can be used recursively to build a hierarchical hash function. When the number of entries in the table corresponding to a given hash value h1=H1(x) increases and passes a threshold level, e.g., 10 entry, then we use the second level hash function H2(.) to sort these entries. We build the hash function such that they are independent and have uniform distribution, i.e., if the input is taken uniformly from the input space, the output is also uniformly distributed in the output space.

### User Location Confusion (Random Polygon)

In the simplest form, the random polygon can be a circle of a certain radius, with the center shifted by a certain distance from the actual sensitive location of the user. More sophisticated polygons with different length sides, and varying distances from the actual sensitive location further increase the complexity of identifying the user location. The circle or the polygon is locally generated by the user and known only to the user. To determine the radius of the circle or the sides of the polygon, a public database of addresses can be used by the user to ensure that enough other addresses are present within the security zone.

Alternately, a large enough area can be chosen by the user herself through explicit knowledge of the location. For example, in a densely populated area, the region can be very small, where as in a sparse area such as rural locality or a farm house, the zone can be large. This way of generating the zone ensures that even after knowing enough points on the edges of the zone, the exact location of the user cannot be accurately determined by anyone.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

What is claimed is:

1. A method comprising the steps of:
transmitting location-specific information by a user device to a service provider;
preserving anonymity of said user device in said transmitting, providing incentives to said user device for information upload to said service provider, and
disabling said service provider from associating said user device with said information upload and said location specific information for promoting said information upload.

2. The method of claim 1, wherein said step of preserving user anonymity comprises using a distance defined by said user device around which said anonymity is preserved by not providing updates in the frequently visited regions within said distance defined.

3. The method of claim 2, wherein said distance defined by said user device comprises a random polygon responsive to said distance defined.

4. The method of claim 1, wherein said incentives comprise monetary incentives including using a Pseudo-ID and a Real-ID.

5. The method of claim 1, wherein said incentives comprise encash incentives including use of a signature on an encoded number and removal of the encoding to achieve a signed actual number and use of said signed actual number for receiving said incentive.

6. The method of claim 5, wherein said signed actual number can be verified and unassociated with said signed actual number.

7. The method of claim 4, wherein using said Pseudo-ID comprises using said pseudo-ID for a signature on an encoded number.

8. The method of claim 7, wherein using said Pseudo-ID comprises removing the encoding from said encoded number for a signed actual number.

9. The method of claim 4, wherein using said Real-ID comprises using a signed actual number with said Real-ID for receiving said incentive by said user device, said signed actual number being derived from said Pseudo-ID, verifiable and unassociated with said Pseudo-ID.

10. The method of claim 4, said Pseudo-ID being generated by a trusted third party, verifiable by said service provider, and incapable of being created or reproduced by any other said user device.

11. The method of claim 10, wherein said Pseudo-ID comprises part of a number as clear text directly usable as efficient indexing of multiple ones of said user devices in a database used by said service provider.

12. The method of claim 1, wherein said incentives comprise encash incentives from a transaction between said user device and said service provider under first and second encashment protocols, said first and second encashment protocols being separable in time and network connection used.

13. The method of claim 12, wherein said encashment protocols being separable in time and network connection used comprises releasing a network connection between said user device and said service provider and re-acquiring a new connection to be assigned a new network ID including an Internet Protocol address.

14. The method of claim 1, wherein said user device is one of multiple user devices capable of being sensors for respective ones of said location specific information, and said incentives comprising a transaction between said user device and said service provider to encash said incentives, said transaction including a two-step encashment protocol.

15. The method of claim 14, wherein said two-step encashment protocol comprises a first step using a Pseudo-ID for achieving a signature on an encoded number and removing the encoding for achieving a signed actual number, and a second step using said signed actual number with a Real-ID for receiving said incentive, said signed actual number being verifiable and incapable of being associated with said Pseudo-ID.

16. The method of claim 15, wherein said Pseudo-ID can be generated by a trusted third party and verifiable by said service provider and incapable of being created or reproduced by any other party including other said user devices.

17. The method of claim 15, wherein said first and second step are separable in time and network connection being used.

18. The method of claim 15, wherein said first and second step are separable in time and network connection used by releasing said network connection and reacquiring a new network connection and assigning a new network identification ID.

19. A wireless system comprising:
a service provider responsive to a user device transmitting its location-specific information by a user and for providing an incentive to said user device for an information upload to said service provider while preserving anonymity of said user device with said service provider being incapable of associating said user device with said respective information upload and said location specific information.

20. The method of claim 19, wherein said user device and said service provider cooperate to preserve user anonymity using a distance defined by said user device around which said anonymity is preserved by not providing updates in the frequently visited regions within said distance defined.

21. The method of claim 20, wherein said distance defined by said user device comprises a random polygon responsive to said distance defined.

22. The method of claim 19, wherein said incentives comprise monetary incentives including using a Pseudo-ID and a Real-ID.

23. The method of claim 19, wherein said incentives comprise encash incentives including use of a signature on an encoded number and removal of the encoding to achieve a signed actual number and use of said signed actual number for receiving said incentive.

24. The method of claim 23, wherein said signed actual number can be verified and unassociated with said signed actual number.

25. The method of claim 22, wherein using said Pseudo-ID comprises using said pseudo-ID for a signature on an encoded number.

26. The method of claim 25, wherein using said Pseudo-ID comprises removing the encoding from said encoded number for a signed actual number.

27. The method of claim 22, wherein using said Real-ID comprises using a signed actual number with said Real-ID for receiving said incentive by said user device, said signed actual number being derived from said Pseudo-ID, verifiable and unassociated with said Pseudo-ID.
